(19) United States
(12) Patent Application Publication
(10) Pub. No.: US 2014/0164915 A1
(43) Pub. Date: Jun. 12, 2014

(54) CONVERSION OF NON-BOOK DOCUMENTS FOR CONSISTENCY IN E-READER EXPERIENCE

(71) Applicant: MICROSOFT CORPORATION, Redmond, WA (US)

(72) Inventors: Ming Liu, Bellevue, WA (US); Raman Narayanan, Seattle, WA (US); Wei Zeng, Sammamish, WA (US); Qian Zhang, Issaquah, WA (US)

(73) Assignee: Microsoft Corporation, Redmond, WA (US)

(21) Appl. No.: 13/711,342

(22) Filed: Dec. 11, 2012

(51) Int. Cl. G06F 17/21

(52) U.S. Cl. CPC G06F 17/211
USPC 715/249

(57) ABSTRACT

“Non-book” documents such as user documents, enterprise documents, and other content are automatically converted into a format consistent with e-books, categorized, and presented through an e-reader application in a consistent manner to enhance e-reader experience. Content received from a variety of sources such as organizational data sources, professional or social network sources, and even a user's own domain is analyzed, reformatted for consistency with other e-reader content, and categorized. The user can use the e-reader application to read e-books, review professional or personal documents, magazine articles, etc. taking advantage of enhanced e-reader features such as context based searches, sharing, snippets, note taking, inking, and comparable ones.

### BACKGROUND

Mobile computing has transformed media consumption across markets. Miniaturization across product generations has enabled more functionality to be accomplished by smaller devices. A modern smartphone has more computing capacity than a desktop computer a few years ago. Mature product processes have also enabled advances in technology to be integrated to automated production of mobile devices seamlessly. Extensive automation has led to inexpensive components. Inexpensive components have enabled manufacturing of inexpensive mobile devices providing functionality on the go.

Recently, content has been making an accelerated march towards digital. Professionally published books and magazines are the most recent segment moving to digital domain with a variety of reader devices and platforms offering different aspects of user experience. Providers of e-reading services aim for compelling devices, satisfying reading experiences, rich catalog of digitized content with an easy commerce experience, a walled backend increasingly capable of hosting multiple content types, and early features in annotations and sharing features. One of the limiting factors of conventional e-readers is that they are typically limited to specific content, e.g., e-books. Thus, a user would have to maintain and carry around a separate device/application just for reading books in electronic format.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling conversion of “non-book” documents such as user documents, enterprise documents, and other content into a format consistent with e-books, automatic categorization of such converted documents, and presentation through an e-reader application in a consistent manner to enhance e-reader experience. Content received from a variety of sources such as organizational data sources, professional or social network sources, and even a user's own domain may be analyzed, reformatted for consistency with other e-reader content, and categorized. The converted documents may then be presented through one or more user interfaces in a seamless, consistent manner such that the user can use the e-reader application to read e-books, review professional or personal documents, magazine articles, etc. taking advantage of enhanced e-reader features such as context based searches, sharing, snippets, note taking, inking, and comparable ones.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example e-reader service based document conversion according to some embodiments;

FIG. 2 illustrates an example a local e-reader application based document conversion according to other embodiments;

FIG. 3 illustrates an example e-reader user interface presenting converted documents according to automatically determined, suitable categories;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of converting documents to suitable e-reader content automatically in an e-reader environment according to embodiments.

### DETAILED DESCRIPTION

As briefly described above, conversion of “non-book” user documents, enterprise documents, and other content may be converted into a format consistent with e-books, automatically categorized, and presented through an e-reader application in a consistent manner to enhance e-reader experience. Content received from a variety of sources such as organizational data sources, professional or social network sources, and even a user's own domain may be presented, upon conversion, through one or more user interfaces in a seamless, consistent manner such that the user can use the e-reader application to read e-books, review professional or personal documents, magazine articles, etc. taking advantage of enhanced e-reader features such as context based searches, sharing, snippets, note taking, inking, and comparable ones.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for converting documents to e-reader content for consistent, enhanced e-reader experience. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

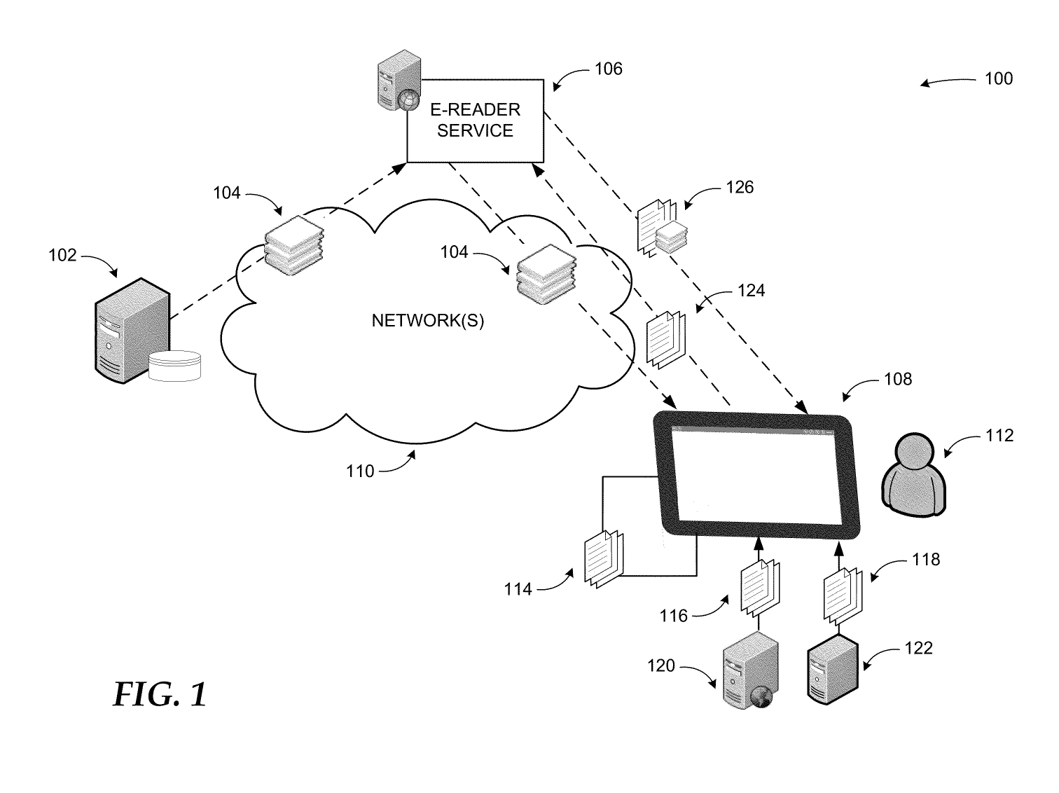

FIG. 1 illustrates an example e-reader service based document conversion according to some embodiments. The components and environments shown in diagram 100 are for illustration purposes. Embodiments may be implemented in various local, networked, cloud-based and similar computing environments employing a variety of computing devices and systems, hardware and software.

An “e-reader” device such as a tablet 108 may host an application providing content to a user 112. Such an application may be called an e-reader application, which may be a locally installed and executed application receiving content (e.g., e-books, documents, etc.) through wired or wireless networks. The e-reader application may also be a hosted service provided by one or more servers (e.g., server 106) and accessed by a user through the e-reader device (e.g., tablet 108). Content may be any type of consumable data including but not exclusive to text, audio, video, graphic, etc. Content may also include media combinations presented in a standardized format (i.e.: a web page.) Content may be provided by a content server 102 hosting the content for consumption by services and devices.

An e-reader application according to embodiments may present content such as an e-book, a magazine article, a newspaper, or even a personal document to user 112 through tablet device 108 and enable enrichment of user experience through context based searches, interactivity, note taking, snippets, inking, and comparable features.

In a typical e-reader service configuration, server 106 may receive content 104 from one or more content sources 102 and make that content 104 available to a plurality of users through devices like tablet 108. The communications and exchange of content may take place over one or more networks 110 with the content 104 being stored either by the e-reader service at a networked data store and managed by server 106 or stored locally at the tablet 108. An e-reader application/service according to embodiments expands the e-reader experience beyond reading of e-books, and enables a user to utilize the e-reader application across a broad spectrum of documents. A typical user may handle a variety of personal, professional, and other documents. For example, tablet 108 or a similar end device providing access to the e-reader service may also store word processing documents, presentation documents, spreadsheet documents, emails, text messages, web pages, and other content associated with the user 112. The user 112 may further have content stored in personal realm (e.g., a remote storage, a personal cloud storage, etc.). All of this personal content is represented by reference number 114 in diagram 100. As mentioned, personal content 114 may or may not be in a format suitable for taking full advantage of e-reader capabilities.

In addition to personal content 114, user 112 may be associated with an organization (e.g., an employee of an enterprise) and receive, create, maintain professional documents (of the types discussed above) from/at an enterprise server 122. Some or all of the professional content 118 may be stored by the enterprise server 122 or some may be stored locally at the tablet 108. Furthermore, user 112 may participate in social or professional networks, subscribe to news feeds or similar information sources, and receive documents 116 from different sources such as web server 120. Documents 116 and professional content 118 may also be in a variety of formats as discussed in conjunction with personal content 114.

In an e-reader system according to embodiments, the e-books or similar content may be in a standardized format such as EPUB3 or HTML to enable the e-reader application provide a full set of enhanced capabilities to the user such as context based searches, sharing of content, capture/copy/paste of snippets, use of snippet directors for navigation, note taking, inking, and many more. A personal or professional document in a different format may not allow the e-reader application to fully utilize the enhanced e-reader capabilities, thereby degrading user experience. In a system according to embodiments, any document (content) 124 may be submitted to the e-reader service at server 106 from the tablet 108 for conversion to an e-reader format. The e-reader service may analyze submitted document 124, determine one or more suitable categories, convert its format (augmenting with additional features in some cases), and enable presentation as converted content 126 consistent with remaining e-book or e-book-like content available through the e-reader service.

The conversion may include, for example, pre-processing to augment the content with a set of enhanced e-reader capabilities. For example, context based search capabilities may be taken advantage of using key terms determined within the content. Search results may be ranked and those above a predefined threshold selected for augmentation into the converted content 126. In addition images, audio/video objects, interactive objects, etc. may be inserted and the converted content 126 stored in a default format such as EPUB or HTML.

Embodiments are not limited to implementation in a tablet 108 as user end device. In addition to touch or gesture enabled interactions, other input mechanisms such as standard mouse and keyboard interface, gyroscopic input devices, eye-tracking, and similar inputs may also be employed. In some examples, the e-reader service may convert shared documents (e.g., collaboration documents) and make available to multiple users. In other examples, the e-reader application may perform the conversion for individual users based on user preferences, etc. as discussed below.

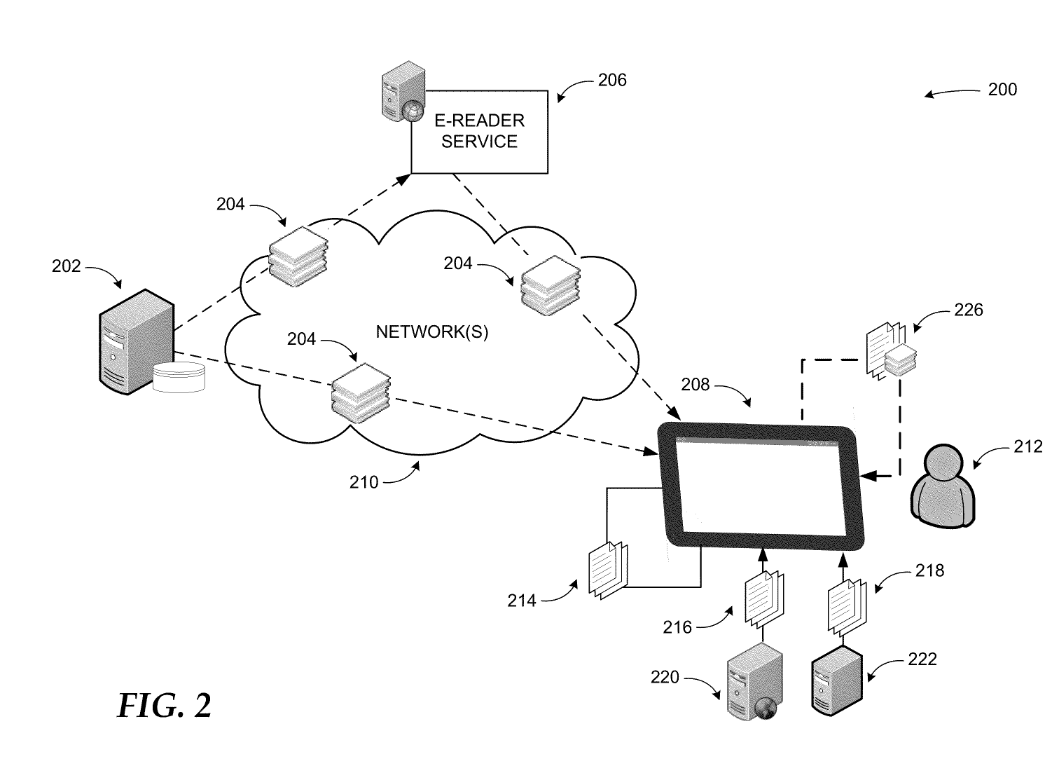

FIG. 2 illustrates an example a local e-reader application based document conversion according to other embodiments. Diagram 200 displays a local e-reader application based system as an alternative to the example architecture described in FIG. 1.

In the example configuration of diagram 200, e-book content 204 may be provided from the content server 202 to the e-reader application executed on tablet 208 directly or via the e-reader service executed on server 206 using one or more networks 210. User 212 may also be associated with professional content 218 from enterprise server 222, documents 216 from web server 220, and personal content 214 in a personal realm. Differently from the configuration in FIG. 1, the e-reader application executed on tablet 208 may perform the analysis, conversion, and categorization in the configuration of diagram 200, and present converted content 226 along with other e-books, etc.

An e-reader application according to embodiments may support a wide variety of electronic document formats such as PDF, DOC, PPT, EPUB2, EPUB3, HTML, etc. Each of these exemplary formats is associated with different types of native applications and enables different features to be implemented through the e-reader application. Of the formats, EPUB is an approach to package websites in an offline package. It is a zip file with XHTML documents which host the book content, packaging files that contain book metadata and describe the structure of the book, and container files that describe the root pointer to the content and any content protection scheme. The signature feature of EPUB is reflowable text that can be read optimally on a variety of reading systems. EPUB3 facilitates creation of books with modern content. The base content format is XHTML5 and supports SVG objects, MathML, CSS3 (with some extensions that haven't been ratified by W3C yet), and scriptable behaviors in Javascript. With the upgrades in content format, navigation, scripting, styling, media, and character sets, EPUB3 may facilitate creation of compelling book content.

Thus, embodiments enable personal and/or organizational document sources to be used to import documents/content into the user's library in same/similar format as books allowing the user to take advantage of enhanced reader capabilities for consistent reading experience and a uniform set of services. Locally stored data associated with converted documents may be updated based on changes at the user/organizational sources, reader service, and/or user actions.

In some embodiments, a control may be provided on a browser user interface for enabling a user to convert web pages to e-reader content. Upon activation of the control, the browser may retrieve a script from an e-reader service and execute the script locally processing the web page as described herein. The processed page may be sent to the e-reader and further processed (e.g., converted to e-reader format). If the web page includes multiple pages linked together in some fashion, the processing may include retrieving the additional pages automatically. In other embodiments, the e-reader service may provide a link that can be dragged onto the browser user interface as the control for the conversion.

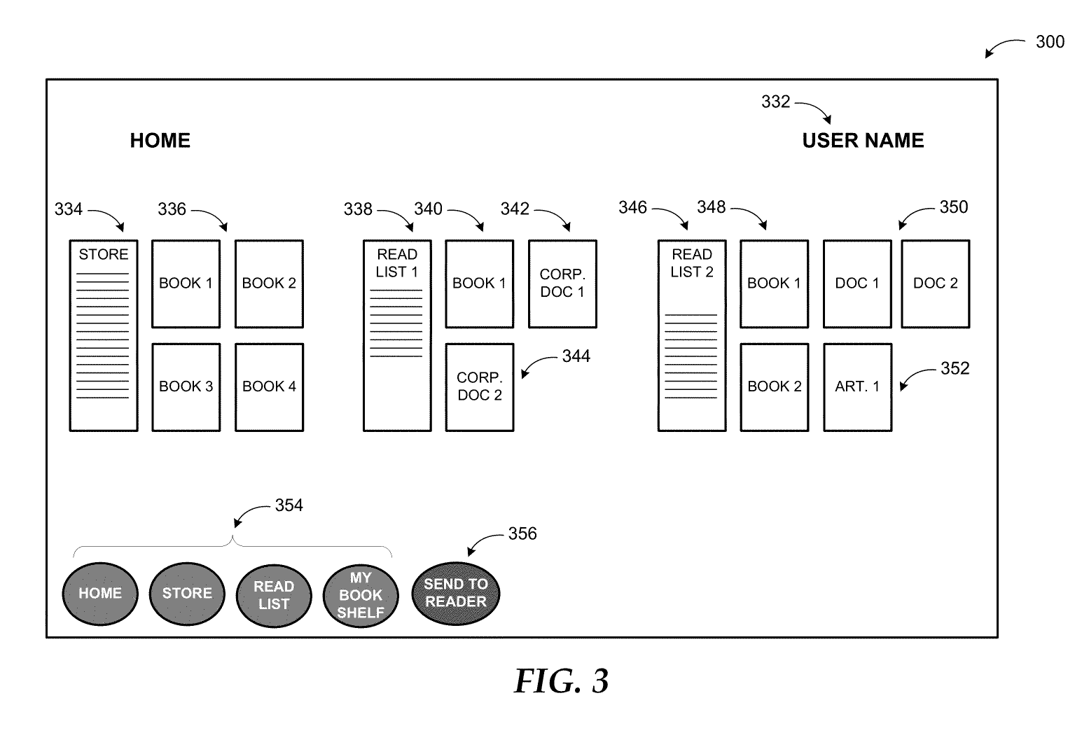

FIG. 3 illustrates an example e-reader user interface presenting converted documents according to automatically determined, suitable categories. As shown in the example e-reader user interface of diagram 300, available content may be presented to a user in various categories.

The e-reader user interface may present in a “Home” configuration a listing of content 334 available at the content store, content 338 under a reading list 1 category, and content 346 under a reading list 2 category. The user interface may present other configurations, where, for example, available content is categorized by genre, by type, by size, by recentness, etc. Controls 354 may enable a user to switch between different presentation screens.

In the illustrated user interface, the “Home” configuration for user 332 includes a number of books available from the store. Of those, four (336) are shown in more detail (e.g., cover pages). Next, a reading list 1 category may include content 338, which is mostly professional content. Thus, a book 340 and corporate documents 342 and 344 may be included under this category. Reading list 2 category may include content 346, which may be mostly personal content. Thus, the content listed under this category may include a book 348, two documents 350 (e.g., letters, or emails), an article 352, and so on.

In some embodiments, the e-reader user interface may present standard e-reader content and unconverted documents such that the user can select which documents they want to have converted. Upon selecting a document, the user may activate a control such as “Send To Reader” button 356 initiating the analysis, categorization, and conversion process. The converted documents may be distinguished from unconverted documents by a visual scheme such as a color scheme, a shading scheme, a highlighting scheme, a textual scheme, a 3D scheme, etc. For example, unconverted documents may be shown in flat form. Upon conversion, the newly formatted documents may be presented with a 3D effect emphasizing their consistency with e-books. Of course, other schemes and approaches may be utilized as well.

As mentioned above, documents to be sent to the reader may be analyzed during pre-processing and a proper reading list may be selected for placing the document into. There may be a single reading list or multiple lists based on user preferences (based on content, date, type, etc.). For example, work related documents may be placed into a reading list that includes also work related books (e.g., technical books), while personal email correspondences may be placed into a personal reading list that includes novels selected to be reader currently.

In addition to the “Send To Reader” button 356 on a browser or e-reader user interface, the conversion process may be completely automatic. For example, the user may select a new article on a web page to be sent to the reader. The application may strip extraneous content (ads, other information unrelated to the article), organize the comments based on the user's option, extract the complete content automatically (by analyzing page linkage) across sites when the article is published in multiple pages, title, author, publisher and publish date are identify/convert the HTML to EPUB or selected format of the reader, reflow the content according to reader settings (e.g., display settings), and place in the proper reading list.

In another example, a PDF document may be converted to a Word document, then to an HTML document, from there to EPUB. Rich content may be added to the flat PDF document allowing the end result to be an interactive document. For personal documents (created or received from personal/organizational domain), processing may be performed at time of creation at e-reader.

According to some embodiments, personal document integration may be provided as a web service. Server-side conversion may be performed and documents downloaded back to client library. The original document may be opened in a viewer (e.g., PDF viewer for PDF documents) to show the contents quickly. The same document may then be shown in e-reader (with font size adjusted for example). Other documents that are already pre-processed may also be shown for user selection (storage, viewing). The processing may bring static content to life, preserve formatting, and allow pagination and reflow.

The example scenarios and configurations in FIG. 1 through 3 are shown with specific formats, data types, and configurations. Embodiments are not limited to systems according to these example configurations. Providing document conversion in an e-reader environment may be implemented in configurations employing fewer or additional components in applications and user interfaces. Furthermore, the example schema and components shown in FIG. 1 through 3 and their subcomponents may be implemented in a similar manner with other values using the principles described herein.

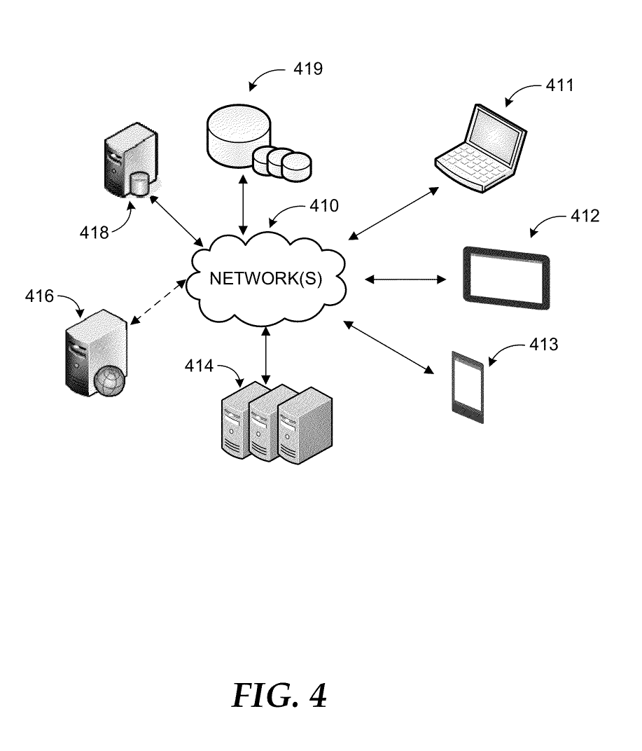

FIG. 4 is a networked environment, where a system according to embodiments may be implemented. Local and remote resources may be provided by one or more servers 414 or a single server (e.g. web server) 416 such as a hosted service. An e-reader application may be executed on individual computing devices such as a smart phone 413, a tablet device 412, or a laptop computer 411 (‘client devices’) and communicate with a content resource through network(s) 410. Data across the devices 413,412, 411 are fully synchronized.

As discussed above, an e-reader application may convert personal and professional documents, categorize them, and present the converted document consistently with other e-reader content in an e-reader environment. Client devices 411-413 may enable access to applications executed on remote server(s) (e.g. one of servers 414) as discussed previously. The server(s) may retrieve or store relevant data from/to data store(s) 419 directly or through database server 418. Further, client devices may connect via near field communications such as Bluetooth, identify each other, and automatically share documents according to user preferences.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to convert documents in an e-reader environment. Furthermore, the networked environments discussed in FIG. 4 are for illustration purposes only. Embodiments are not limited to the example applications, modules, or processes.

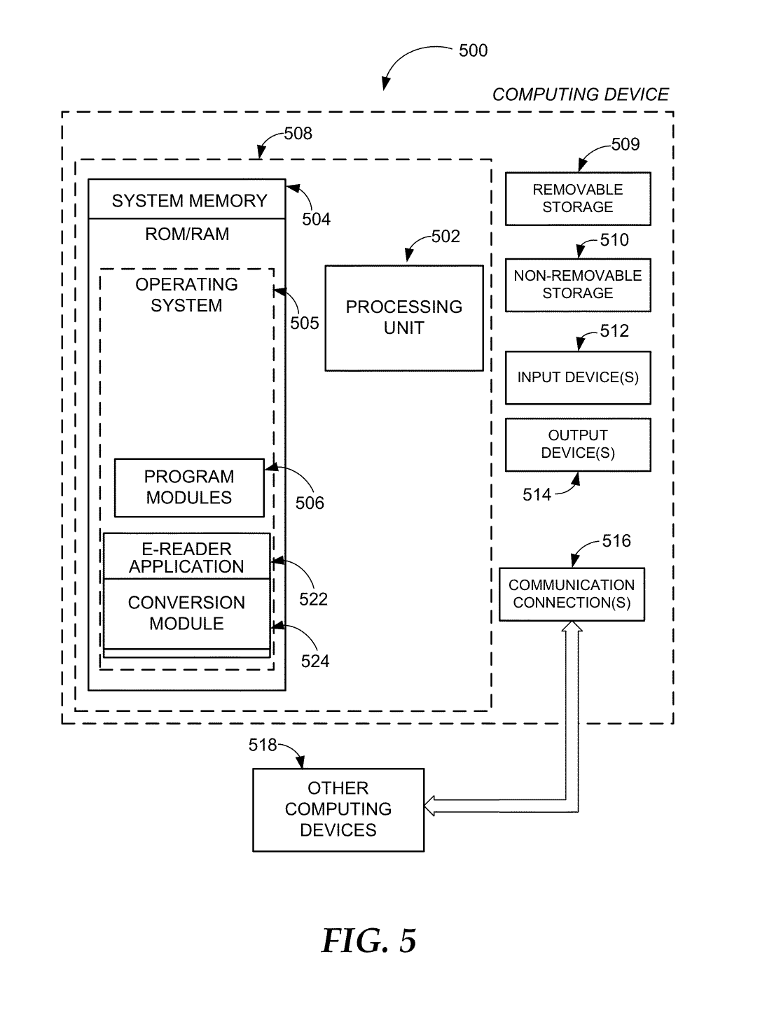

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® and WINDOWS PHONE® operating systems from MICROSOFT CORPORATION of Redmond, Wash. The system memory 504 may also include one or more software applications such as program modules 506, an e-reader application 522, and a conversion module 524.

An e-reader application 522 may manage content for users including e-books and e-book-like content. Conversion module 524 may analyze, categorize, and convert various personal and professional user documents enabling presentation of these documents along with other e-reader content in a consistent manner taking advantage of enhanced e-reader features. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. Computer readable storage media is a computer readable memory device. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

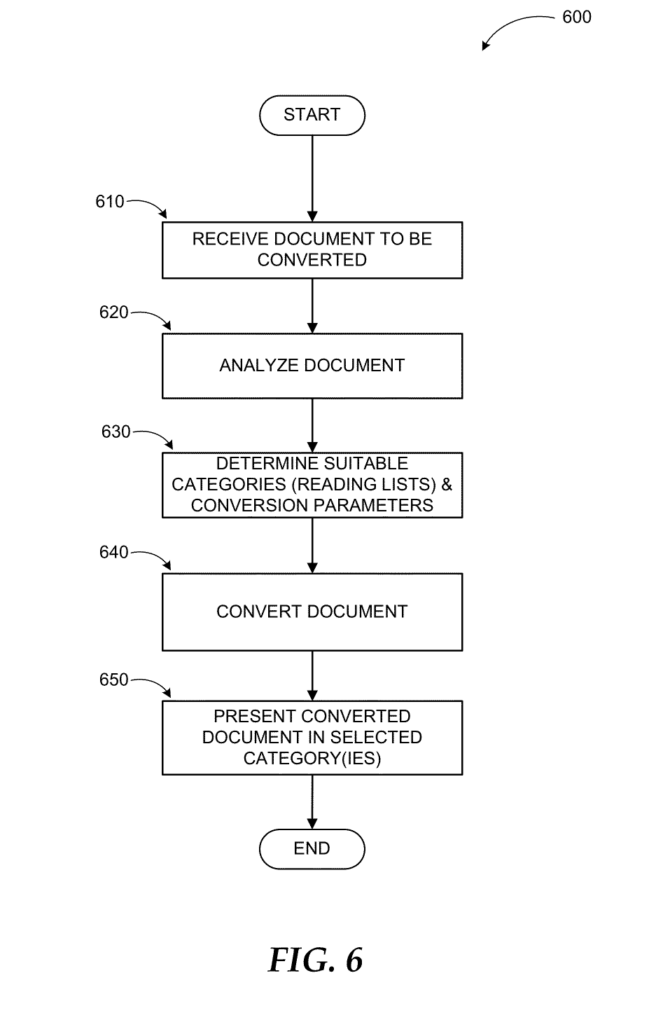

FIG. 6 illustrates a logic flow diagram for a process of converting documents to suitable e-reader content automatically in an e-reader environment according to embodiments. Process 600 may be implemented by an e-reader application or service in some examples.

Process 600 may begin with operation 610 where the e-reader application may receive a user document to be converted. The user may select a document and indicate through a direct action (e.g., a “Send To Reader” button) to the e-reader application the need for conversion. In other embodiments, the e-reader application may be configured to convert selected user documents automatically (e.g., any received email, any word processing document saved in a particular directory, etc.).

At operation 620, the document may be analyzed for its content, type, format, metadata, etc. Based on the analysis results, the e-reader application may determine one or more categories for the document at operation 630 and also determine conversion parameters. For example, the e-reader application may maintain multiple reading lists for the user and decide to list the converted document in one or more of those lists based on the analysis of its contents and its type. The conversion may also be performed based on the analysis results. For example, the content of the document may not be changed during the conversion for professional documents, but for personal documents, augmentation using context-based search may be provided as an additional service further enriching such documents.

At operation 640, the document may be converted as discussed above to a format commonly used for other e-reader content (e.g., e-book format) to provide consistency in presentation and services. At operation 650, the converted document may be presented in its assigned category(ies) alongside other e-reader content.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 600 are for illustration purposes. Converting documents in an e-reader application, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for providing content variety with consistency in an e-reader environment, the method comprising:
receiving a document to be converted to a standardized e-reader format;
analyzing the document;
determining one or more categories and one or more conversion parameters for the document based on results of the analysis;
converting the document to the standardized e-reader format employing the one or more conversion parameters; and
presenting the converted document under the one or more categories through an e-reader user interface.

2. The method of claim 1, wherein receiving the document to be converted comprises one of: receiving a user action indicating the document to be converted and automatically selecting the document to be converted based on an attribute of the document.

3. The method of claim 2, wherein the attribute of the document includes one or more of the document being saved in a predefined directory and the document being provided by a predefined information source.

4. The method of claim 3, further comprising:
receiving the document to be converted from one of: a personal data source, a professional data source, a social network, a professional network, and a news feed.

5. The method of claim 1, further comprising:
enabling one or more interactivity features to be implemented on the converted document, the interactivity features comprising: inline note taking, inking, snippets selection, snippet based navigation, sharing of content, layout reflow upon device change, and context based search of local and web-based data.

6. The method of claim 1, further comprising:
receiving the document to be converted at a hosted e-reader service;
performing the analysis and the conversion at the e-reader service; and
presenting the converted document through a user interface of one of a browser and an e-reader client application configured to access the e-reader service.

7. The method of claim 6, further comprising:
converting a plurality of shared documents at the e-reader service; and
making the converted shared documents available to a plurality of users.

8. The method of claim 1, further comprising:
receiving the document to be converted at an e-reader application;
performing the analysis and the conversion at the e-reader application; and
presenting the converted document through a user interface of the e-reader application.

9. The method of claim 8, further comprising:
performing the analysis and the conversion based on one or more user preferences.

10. The method of claim 1, further comprising:
displaying the document on a user interface prior to the conversion; and
displaying the converted document on the user interface under the one or more categories employing a visual scheme to distinguish the document and the converted document.

11. The method of claim 1, wherein the visual scheme includes one or more of: a color scheme, a shading scheme, a highlighting scheme, a textual scheme, and a 3D scheme.

12. A computing device for providing content variety with consistency in an e-reader environment, the computing device comprising:
a memory configured to store instructions; and
a processor coupled to the memory, the processor executing an e-reader application in conjunction with the instructions stored in the memory, wherein the e-reader application is configured to:
receive a document to be converted to a standardized e-reader format from one of: a personal data source, a professional data source, a social network, a professional network, and a news feed;
analyze the document;
determine one or more categories and one or more conversion parameters for the document based on results of the analysis;
convert the document to the standardized e-reader format employing the one or more conversion parameters; and
present the converted document under the one or more categories through an e-reader user interface.

13. The computing device of claim 12, wherein the e-reader application is further configured to:
enable interaction for a user through one or more of a touch input, a gesture input, a mouse input, a keyboard input, a gyroscopic input, and an eye-tracking input.

14. The computing device of claim 12, wherein the document is one of: a word processing document, a presentation document, a spreadsheet document, an email, a text message, and a web page.

15. The computing device of claim 12, wherein the personal data source includes one of a local data store at the computing device, a remote data store, and a personal cloud data store.

16. The computing device of claim 12, wherein the e-reader application is further configured to:
convert the document employing context based search based on key terms determined within the document during the analysis, ranking search results, selecting search results above a predefined threshold for augmentation into the converted document, wherein the augmentation includes one or more of images, audio/video objects, interactive objects, and textual data; and
store the converted document in one of EPUB and HTML formats.

17. A computer-readable memory device with instructions stored thereon for providing content variety with consistency in an e-reader environment, the instructions comprising:
receiving a document to be converted to a standardized e-reader format based on one of: receiving a user action indicating the document to be converted and automatically selecting the document to be converted based on an attribute of the document;
analyzing the document;
determining one or more categories and one or more conversion parameters for the document based on results of the analysis;
converting the document to the standardized e-reader format employing the one or more conversion parameters;
presenting the converted document under the one or more categories through an e-reader user interface; and
enabling one or more interactivity features to be implemented on the converted document, the interactivity features comprising: inline note taking, inking, snippets selection, snippet based navigation, sharing of content, layout reflow upon device change, and context based search of local and web-based data.

18. The computer-readable memory device of claim 17, wherein the instructions further comprise:
receiving the document in a web page format;
removing extraneous content from the document;
identifying a previous and a next page link and concatenate main content from multiple pages to a single complete document;
converting the document to the standardized e-reader format; and
reflowing the converted document according to settings of a computing device executing an e-reader application.

19. The computer-readable memory device of claim 18, wherein the instructions further comprise:
presenting the converted document under one or more categories in one or more user interfaces of the e-reader application.

20. The computer-readable memory device of claim 17, wherein the instructions further comprise:
receiving the document to be converted through one of: receiving a user action indicating the document to be converted and automatically selecting the document to be converted based on one or more of the document being saved in a predefined directory and the document being provided by a predefined information source.
